(19) United States
(12) Patent Application Publication
(10) Pub. No.: US 2013/0163247 A1
(43) Pub. Date: Jun. 27, 2013

(54) LAMP BASE AND LAMP HAVING THE SAME

(71) Applicant: TSUNG-CHI LEE, TAIPEI (TW)

(72) Inventor: TSUNG-CHI LEE, TAIPEI (TW)

(73) Assignees: LITE-ON TECHNOLOGY CORP., TAIPEI (TW); SILITEK ELECTRONIC (GUANGZHOU) CO., LTD., GUANGZHOU (CN)

(21) Appl. No.: 13/537,275

(22) Filed: Jun. 29, 2012

(30) Foreign Application Priority Data
Dec. 21, 2011 (CN) 201110448579.4

(51) Int. Cl. F21V 29/00

(52) U.S. Cl. 362/249.01; 362/382

(57) ABSTRACT

A lamp includes a lighting module and a lamp base. The lamp base includes a base unit. The base unit includes a first base element and a second base element. The first base element includes a plurality of first channels. The second base element includes a plurality of second channels that are in fluid communication with the second channels, respectively. The thermal conductivity of the second base element is lower than that of the first base element. The lighting module is disposed on the first base element. During operation of the lighting module, an airflow between the first channels and the second channels is accelerated for improving heat-dissipating efficiency due to a pressure difference caused by temperature difference between the first and second base elements.

### CROSS-REFERENCE TO RELATED APPLICATION

This application claims priority of Chinese Application No. 201110448579.4, filed on Dec. 21, 2011.

### BACKGROUND OF THE INVENTION

1. Field of the Invention

This invention relates to a lamp base and a lamp, and more particularly to a lamp base capable of improving heat-dissipating efficiency and a lamp having the lamp base.

2. Description of the Related Art

To solve heat-dissipating problems, a conventional LED lamp is provided with a plurality of radially arranged heat-dissipating fins or a fan for dissipating heat therefrom.

### SUMMARY OF THE INVENTION

The object of this invention is to provide a lamp base and a lamp having the lamp base configured to accelerate airflow through the lamp base for improving heat-dissipating efficiency.

According to an aspect of this invention, a lamp base permits a lighting module to be disposed thereon. The lamp base includes a base unit and a plurality of heat-dissipating fins. The base unit includes a first base element and a second base element. The first base element includes a plurality of first channels. The lighting module is disposed on the first base element. The second base element is connected to the first base element, and includes a plurality of second channels. The second channels are in fluid communication with the first channels, respectively, so as to permit flow of air through the first and second channels. The thermal conductivity of the second base element is lower than that of the first base element. The heat-dissipating fins are formed on at least one of the first and second base elements.

According to another aspect of this invention, a lamp includes the lighting module and the lamp base.

An effect of this invention is that, due to different thermal conductivities of the first and second base elements, heat generated during operation of the lighting module results in temperature difference between the first and second base elements and, thus, pressure difference in the first channels and the second channels, so as to accelerate airflow through the first and second channels, thereby improving heat-dissipating efficiency.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a partly exploded perspective view of the preferred embodiment of a lamp according to this invention, wherein a lamp cover is removed from the remaining portion of the lamp;

FIG. 2 is a partly exploded perspective view of the preferred embodiment, wherein first and second base elements are removed from each other;

FIG. 3 is an exploded perspective view of the preferred embodiment;

FIG. 4 is a top view of the preferred embodiment, the lamp cover being removed;

FIG. 5 is a top view of the second base element of the preferred embodiment;

FIG. 6 is a sectional view taken along line VI-VI in FIG. 4; and

FIG. 7 is an enlarged view of a portion of FIG. 6, illustrating a lighting module of the preferred embodiment.

### DETAILED DESCRIPTION OF THE PREFERRED EMBODIMENT

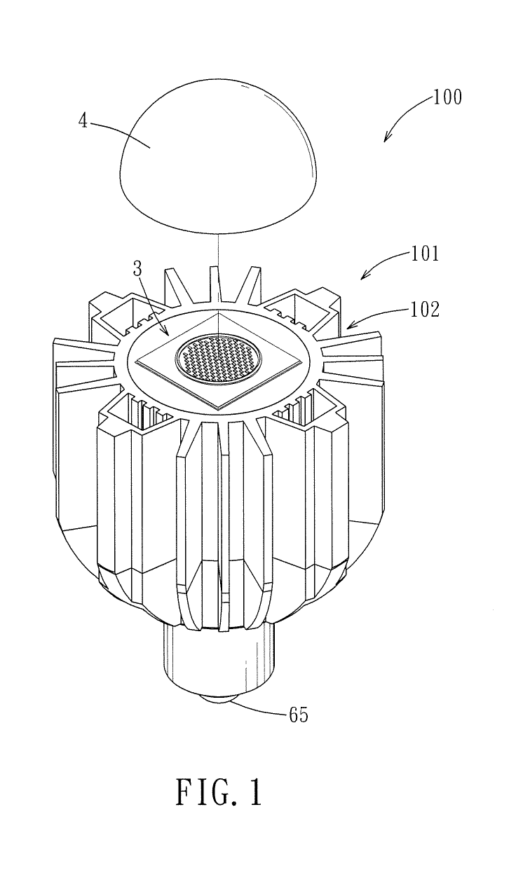

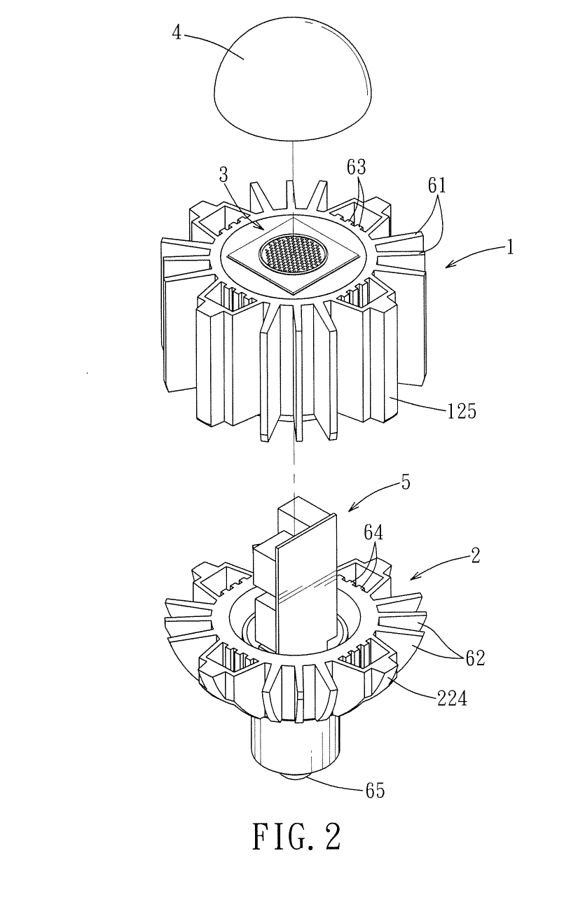

Referring to FIGS. 1 and 2, the preferred embodiment of a lamp 100 according to this invention includes a lamp base 101, a lighting module 3, a lamp cover 4 and a circuit unit 5. In this embodiment, the lighting module 3 is an LED lighting module having a COB (chip-on-board) package structure. In alternative embodiments, the lighting module 3 may be an LED lighting module having other package structure.

The lamp base 101 includes a base unit 102, a plurality of heat-dissipating fins, and an electrode contact 65. The base unit 102 includes a first base element 1 and a second element 2 connected to and disposed under the first base element 1. The lighting module 3 is disposed on the first base element 1. In this embodiment, the heat-dissipating fins include a plurality of first heat-dissipating fins 61, a plurality of second heat-dissipating fins 62, a plurality of third heat-dissipating fins 63, a plurality of fourth heat-dissipating fins 64, a plurality of fifth heat-dissipating fins 125, and a plurality of sixth heat-dissipating fins 224. The first, third, and fifth heat-dissipating fins 61, 63, 125 are formed on the first base element 1. The second, fourth, and sixth heat-dissipating fins 62, 64, 224 are formed on the second base element 2.

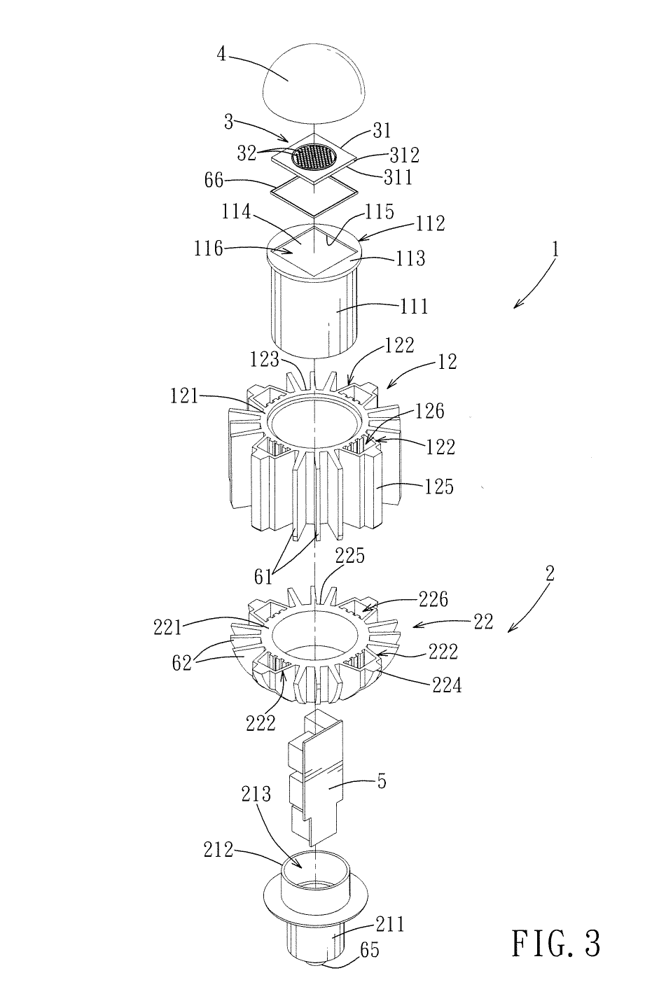

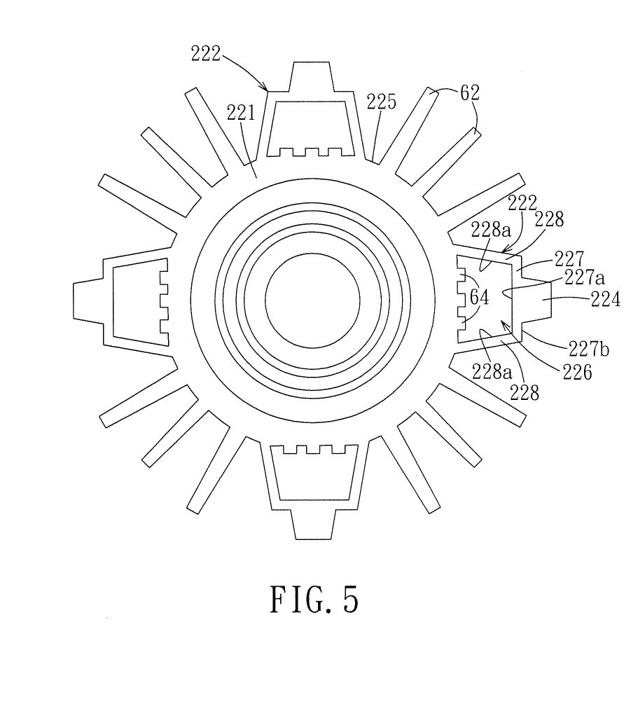

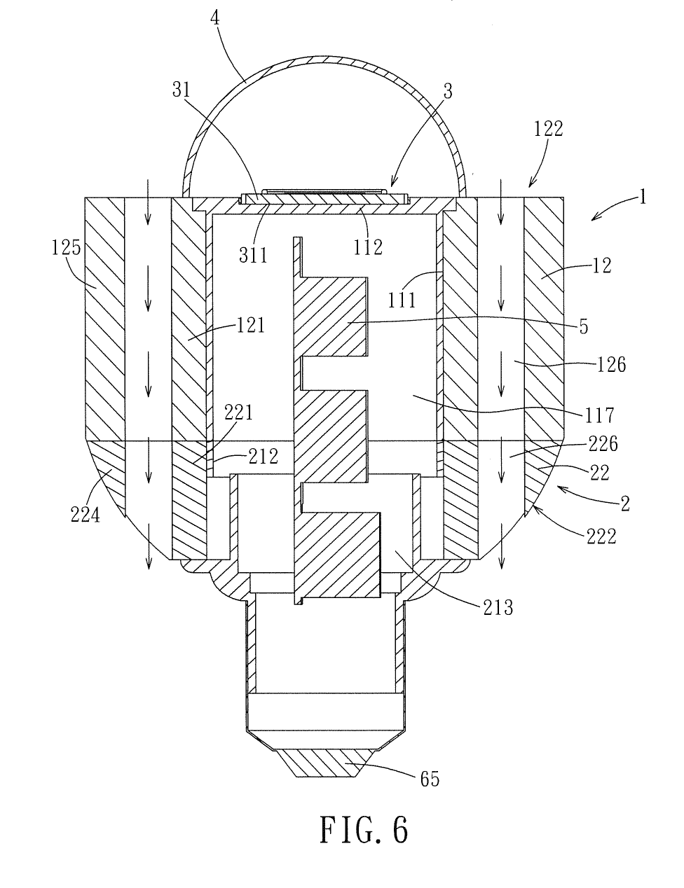

Referring to FIGS. 3 to 6, the first base element 1 includes a first body 12 and a plurality of first plates 122 disposed on the first body 12. The first body 12 includes a vertical tubular first inner surrounding wall 111, a top wall 112 connected to a top end of the first inner surrounding wall 111, and a first outer surrounding wall 121. The top wall 112 has a first top surface 113, a second top surface 114 disposed below the first top surface 113, and an inner side surface 115 interconnecting the first and second top surfaces 113, 114. The inner side surface 115 cooperates with the second top surface 114 to define a recessed area 116. The top wall 112 is connected to the first inner surrounding wall 111 to form a hollow cylindrical structure that is open at a bottom end thereof and that defines an upper accommodating space 117 (see FIG. 6).

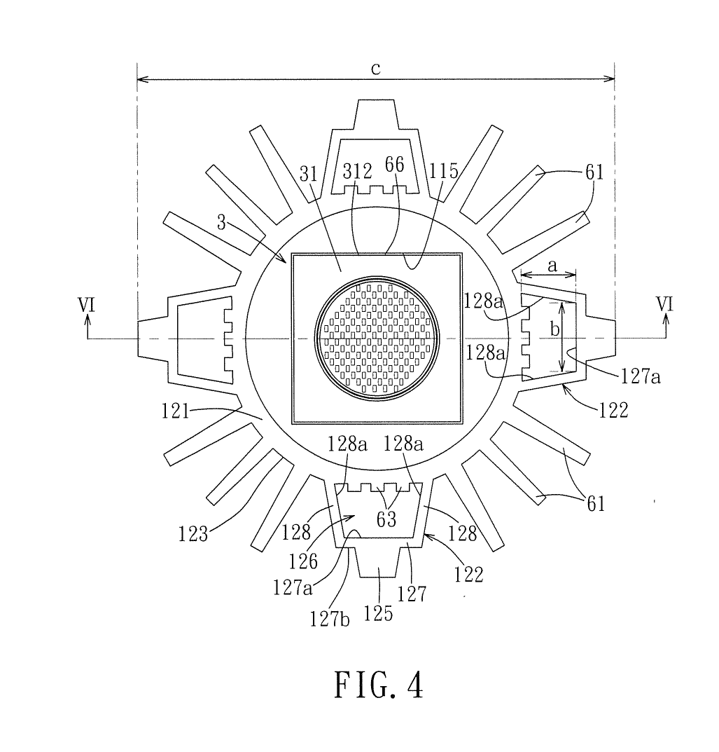

The first outer surrounding wall 121 is annular and vertical, and has a first outer wall surface 123. The first plates 122 are connected to the first outer wall surface 123 of the first outer surrounding wall 121, and are disposed around the first outer surrounding wall 121. In this embodiment, any two adjacent ones of the first plates 122 are angularly spaced apart from each other by an angle of 90 degrees, as shown in FIG. 4. In other words, there are four first plates 122 formed on the first outer wall surface 123 of the first outer surrounding wall 121. However, the number of the first plates 122 is not limited to four, and may be more or less than four. In this embodiment, the first inner surrounding wall 111 is surrounded by the first outer surrounding wall 121, and the top wall 112 is located at a top end of the first outer surrounding wall 121, and has a periphery exposed outwardly from the top end of the first outer surrounding wall 121. The first outer surrounding wall 121 may be connected to the top wall 112.

In this embodiment, each of the first plates 122 is U-shaped in cross-section. Each of the first plates 122 extends vertically, and is connected to the first outer wall surface 123, so as to cooperate with the first outer wall surface 123 to define a vertical first channel 126 that is open at upper and lower ends thereof. The first body 12 and the first plates 122 are formed into one piece. Each of the first plates 122 has a first plate section 127 spaced apart from the first outer wall surface 123, and two second plate sections 128 interconnecting the first section 127 and the first outer wall surface 123 and spaced apart from each other. The first plate section 127 of each of the first plates 122 has a first inner wall surface 127a facing the first outer wall surface 123, and a third outer wall surface 127b opposite to the first inner wall surface 127a. Each of the second plate sections 128 has a second inner surface 128a. The second inner wall surfaces 128a of the two second plate sections 128 of each of the first plates 122 face each other.

The fifth heat-dissipating fins 125 project respectively from the third outer wall surfaces 127b of the first plate sections 127 of the first plates 122, and extend vertically. The first heat-dissipating fins 61 project outwardly from the first outer wall surface 123, also extend vertically, and are arranged in a plurality of spaced groups that are arranged alternately with the first plates 122, such that each group of the first heat-dissipating fins 61 is disposed between two adjacent ones of the first plates 122. Each of the third heat-dissipating fins 63 projects outwardly from the first outer wall surface 123, is disposed within a corresponding one of the first plates 122, and extends into the corresponding first channel 126 in a direction toward the first inner wall surface 127a of the corresponding first plate section 127.

The second base element 2 includes a second body 22 and a plurality of second plates 222 disposed on the second body 22. The second body 22 has a bottom portion 211, a vertical tubular second inner surrounding wall 212 connected to and extending upwardly from the bottom portion 211, and a second outer surrounding wall 221. The second inner surrounding wall 212 and the bottom portion 211 cooperate to define a lower accommodating space 213. The electrode contact 65 is disposed on a lower end of the bottom portion 211 of the second body 22.

The second outer surrounding wall 221 is annular and vertical, and has a second outer wall surface 225. The second plates 222 are connected to the second outer wall surface 225 of the second outer surrounding wall 221, and are disposed around the second outer surrounding wall 221.

The second plates 222 are aligned respectively with the first plates 122. The second inner surrounding wall 212 is surrounded by the second outer surrounding wall 221. The electrode contact 65 disposed on the bottom portion 211 is exposed outwardly from and disposed under the second outer surrounding wall 221.

In this embodiment, the second outer surrounding wall 221 and the second plates 222 are formed into one piece. Each of the second plates 222 is U-shaped in cross-section, extends vertically, and is connected to the second outer wall surface 225 of the second outer surrounding wall 221, so as to cooperate with the second outer wall surface 225 to define a vertical second channel 226 that is open at upper and lower ends thereof. Each of the second plates 222 has a third plate section 227 spaced apart from the second outer wall surface 225, and two fourth plate sections 228 interconnecting the third plate section 227 and the second outer wall surface 225 and spaced apart from each other. The third plate section 227 of each of the second plates 222 has a third inner wall surface 227a facing the second outer wall surface 225, and a fourth outer wall surface 227b opposite to the third inner wall surface 227a. Each of the fourth plate sections 228 has a fourth inner wall surface 228a. The fourth inner wall surfaces 228a of the two fourth plate sections 228 of each of the second plates 222 face each other.

The sixth heat-dissipating fins 224 projects respectively from the fourth outer wall surfaces 227b of the third plate sections 227, and extend vertically. The second heat-dissipating fins 62 project outwardly from the second outer wall surface 225, and also extend vertically. The second heat-dissipating fins 62 are arranged in a plurality of spaced groups that are arranged alternately with the second plates 222, such that each group of the second heat-dissipating fins 62 is disposed between two adjacent ones of the second plates 222. Each of the fourth heat-dissipating fins 64 projects outwardly from the second outer wall surface 225, is disposed within a corresponding one of the second plates 222, and extends into the corresponding channel 226 in a direction toward the third inner wall surface 227a of the corresponding third plate section 227. In other words, each of the fourth heat-dissipating fins 64 is formed in the corresponding second channel 226.

The second base element 2 is connected to and disposed under the first base element 1, such that the upper and lower accommodating spaces 117, 213 are in fluid communication with each other for receiving the circuit unit 5 therein. The circuit unit 5 is electrically connected to the lighting module 3 disposed on the top wall 112 of the first body 12 and the electrode contact 65 disposed on the bottom portion 211 of the second body 22. The first base element 1 and the second base element 2 may be interconnected in any conventional suitable manner. When the first and second base elements 1, 2 are interconnected, a bottom end of the first outer surrounding wall 121 abuts against a top end of the second outer surrounding wall 221, the first plates 122 abut respectively against the second plates 222, the first channels 126 are in fluid communication with the second channels 226, respectively, the first heat-dissipating fins 61 abut respectively against the second heat-dissipating fins 62, the third heat-dissipating fins 63 abut respectively against the fourth heat-dissipating fins 64, and the fifth heat-dissipating fins 125 abut respectively against the sixth heat-dissipating fins 224.

In this embodiment, the cross-section of each of the first heat-dissipating fins 61 is substantially the same as that of the corresponding second heat-dissipating fin 62, the cross-section of each of the third heat-dissipating fins 63 is substantially the same as that of the corresponding fourth heat-dissipating fin 64, and the cross-section of each of the fifth heat-dissipating fins 125 is substantially the same as that of the corresponding sixth heat-dissipating fin 224. As such, each of the first heat-dissipating fins 61 cooperates with the corresponding second heat-dissipating fins 62 to constitute a fin structure that looks like a single fin, each of the third heat-dissipating fins 63 cooperates with the corresponding fourth heat-dissipating fins 64 to constitute a fin structure that looks like a single fin, and each of the fifth heat-dissipating fins 125 cooperates with the corresponding sixth heat-dissipating fin 224 to constitute a fin structure that looks like a single fin.

It should be noted that, the thermal conductivity of the first base element 1 is higher than that of the second base element 2. For example, the first body 12 and the first plates 122 of the first base element 1 are made of a material, such as aluminum or copper, whose thermal conductivity is higher than 200 W/mK, and the second body 22 and the second plates 222 of the second base element 2 are made of a metallic or non-metallic material, whose thermal conductivity is lower than 1 W/mK. In this embodiment, the distance (a) (see FIG. 4) between the first inner wall surface 127a and the first outer wall surface 123 is not less than 5 mm, the distance (b) (see FIG. 4) between the two second inner wall surfaces 128a of each of the first plates 122 is not less than 5 mm, and the base unit 102 (see FIG. 1) has a maximum outer diameter (C) (see FIG. 4) of 70 mm. Preferably, the ratio of the distance (a, b) to the maximum outer diameter (C) of the base unit 102 is about 1/14.

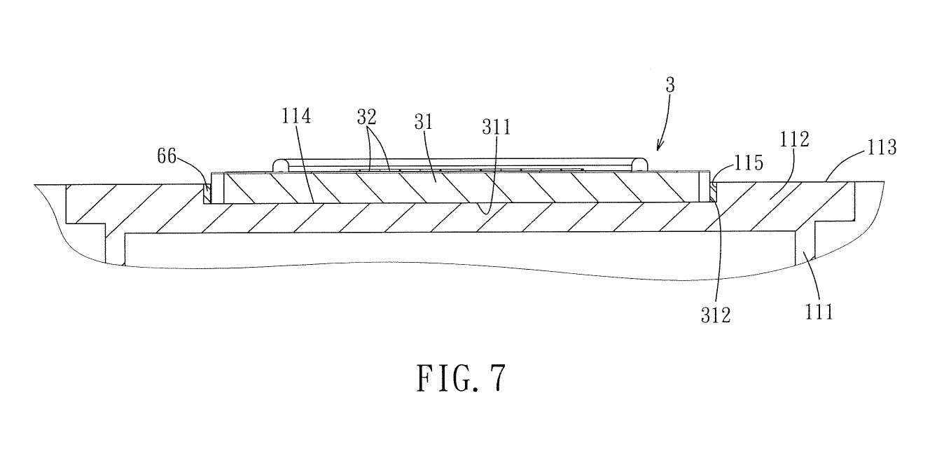

With particular reference to FIGS. 3, 6, and 7, the lighting module 3 includes a substrate 31 and a plurality of light emitting members 32. Alternatively, the lighting module 3 may include only one light emitting member 32. The substrate 31 has a bottom surface 311 and a periphery 312. In this embodiment, the substrate 31 is made of aluminum or ceramics. Each of the light emitting members 32 is an LED disposed on the substrate 31. The lighting module 3 is disposed on the top wall 112 of the first body 12. The bottom surface 311 of the substrate 31 abuts against the second top surface 114 of the top wall 112. The inner side surface 115 of the top wall 112 is disposed around the periphery 312 of the substrate 31. As such, the first and second plates 122, 222 are disposed around the lighting module 3.

In this embodiment, the base unit 102 further includes a heat conducting member 66 surrounding the periphery 312 of the substrate 31. When the lighting module 3 is disposed within the recessed area 116, the heat conducting member 66 is disposed between and abuts against the periphery 312 of the substrate 31 and the inner side surface 115 of the top wall 112, so as to transmit heat therebetween. Preferably, when the lighting module 3 is disposed within the recessed area 116 of the top wall 112, the first top surface 113 of the top wall 112 is not above the light emitting surface of the lighting module 3. The lamp cover 4 is connected to the top end of the first outer surrounding wall 121 of the first body 12 for covering the lighting module 3.

According to the above-mentioned size condition of the base unit 102, an increase in the number of the first plates 122 results in a decrease in the junction temperature of the light emitting members 32. However, when the number of the first plates 122 is too many, the space allowing for disposition of the heat-dissipating fins is reduced. As a result, the number of the heat-dissipating fins must be reduced to thereby affect adversely the heat-dissipating efficiency, so that the junction temperature of the light emitting members 32 is increased largely.

When the lighting module 3 is operated so that heat is generated therefrom, one portion of the heat is dissipated via the first heat-dissipating fins 61 and the second heat-dissipating fins 62 by heat exchange with surrounding air. Besides, since the first base element 1 and the second base element 2 have different thermal conductivities, and since the first channels 126 are in fluid communication with the second channels 226, respectively, another portion of the heat generated from the lighting module 3 is transmitted to the first plates 122, thereby increasing the temperatures of the first plates 122. Hence, the temperature of the first base element 1 is much more than that of the second base element 2, so that the air in the first channels 126 has a temperature and a pressure that are more than those of the air in the second channels 226 due to different thermal conductivities of the first and second base elements 1, 2. Such an air pressure difference between the first and second channels 126, 226 results in an effective amount of airflow from the first channel 126 to the second channel 226 to further enhance dissipation of heat from the lighting module 3. Furthermore, due to guide of the air by the first and second channels 126, 226, the time of contact between the air and the third and fourth heat-dissipating fins 63, 64 is prolonged to dissipate heat more efficiently from the first and second base elements 1, 2.

Further, due to the presence of the recessed area 116 of the top wall 112 of the first body 12 and the heat conducting member 66, the thermal contact areas of the substrate 31 and the top wall 112 are increased, so as to facilitate heat transmission from the substrate 31 to the top wall 112 in a horizontal direction(i.e., heat transmission from the periphery 312 of the substrate 31 to the inner side surface 115 of the top wall 112). Alternatively, the heat conducting member 66 can be omitted, and the recessed area 116 is sized to allow the substrate 31 to be fitted therein, that is, the periphery 312 of the substrate 31 is in contact with the inner side surface 115. In this manner, heat can also be transmitted efficiently from the substrate 31 to the top wall 112 via the inner side surface 115.

Alternatively, the lighting module 3 may include one or more SMD (surface mount device) LEDs. If the lighting module 3 includes a plurality of LEDs, a plurality of recessed areas 116 will be needed for receiving the LEDs, respectively.

Alternatively, the first and second inner surrounding walls 111, 212 may be omitted from the first and second bodies 12, 22, respectively. If this occurs, the top wall 112 may be formed integrally on or connected removably to the top end of the first outer surrounding wall 121, such that the upper accommodating space 117 is defined by the top wall 112 and the first outer surrounding wall 121, and the lower accommodating space 213 is defined by the bottom portion 211 and the second surrounding wall 221.

In view of the above, the first channels 126 in the first base element 1 are in fluid communication with the second channels 226 in the second base element 2, respectively, so as to allow air to flow through the first and second channels 126, 226 to conduct heat exchange with the base unit 102 to thereby dissipate heat from the lighting module 3. Furthermore, since the first and second base elements 1, 2 have different thermal conductivities, an air pressure difference exists between the first channels 126 and the second channels 226, so that an effective amount of airflow from the first channel 126 to the second channel 226 can be generated to promote the heat-dissipating efficiency. Thus, the object of this invention is achieved.

Since the thermal conductivity of the second base element 2 is lower than that of the first base element 1, the second base element 2 may be made of a plastic material, thereby reducing the weight of the base unit 102.

Further, each of the third and fourth heat-dissipating fins 63, 64 extends into a corresponding one of the first and second channels 126, 226, so as to increase the thermal contact area between the air and the base unit 102, thereby further promoting the heat-dissipating efficiency.

With this invention thus explained, it is apparent that numerous modifications and variations can be made without departing from the scope and spirit of this invention. It is therefore intended that this invention be limited only as indicated by the appended claims.

I claim:

1. A lamp comprising:
a lighting module; and
a lamp base including
a base unit including a first base element and a second base element, said first base element permitting said lighting module to be disposed thereon and including a plurality of first channels, said second base element being connected to said first base element and including a plurality of second channels, said second channels being in fluid communication with said first channels, respectively, and being adapted to permit flow of air therethrough, said second base element having a thermal conductivity that is lower than that of said first base element, and
a plurality of heat-dissipating fins formed on at least one of said first and second base elements.

2. The lamp as claimed in claim 1, wherein said first base element includes a first body and a plurality of first plates, said second base element including a second body and a plurality of second plates, said first plates cooperating with said first body to define said first channels, respectively, said second plates cooperating with said second body to define said second channels, respectively.

3. The lamp as claimed in claim 2, wherein said first and second plates are disposed around said lighting module.

4. The lamp as claimed in claim 2, wherein said heat-dissipating fins include a plurality of first heat-dissipating fins formed on said first body, and a plurality of second heat-dissipating fins formed on said second body, said first heat-dissipating fins being arranged in a plurality of spaced groups that are arranged alternately with said first plates, such that each group of said first heat-dissipating fins is disposed between two adjacent ones of said first plates, said second heat-dissipating fins being arranged in a plurality of spaced groups that are arranged alternately with said second plates, such that each of said groups of said second heat-dissipating fins is disposed between two adjacent ones of said second plates.

5. The lamp as claimed in claim 4, wherein said first body includes an annular first outer surrounding wall that has a first outer wall surface, said first plates being connected to said first outer wall surface of said first outer surrounding wall, said second body including an annular second outer surrounding wall that has a second outer wall surface, said second plates being connected to said second outer wall surface of said second outer surrounding wall.

6. The lamp as claimed in claim 5, wherein said first heat-dissipating fins are formed on said first outer wall surface, said second heat-dissipating fins being formed on said second outer wall surface.

7. The lamp as claimed in claim 5, wherein said heat-dissipating fins further includes a plurality of third heat-dissipating fins formed on said first outer wall surface of said first outer surrounding wall and each extending into a corresponding one of said first channels, and a plurality of fourth heat-dissipating fins formed on said second outer wall surface of said second outer surrounding wall and each extending into a corresponding one of said second channels.

8. The lamp as claimed in claim 7, wherein said heat-dissipating fins further includes a plurality of fifth heat-dissipating fins disposed respectively on said first plates, and a plurality of sixth heat-dissipating fins disposed respectively on said second plates, said fifth heat-dissipating fins abutting respectively against said sixth heat-dissipating fins when said first and second base elements are interconnected.

9. The lamp as claimed in claim 5, wherein each of said first plates has a first plate section spaced apart from said first outer wall surface, and two second plate sections interconnecting said first section and said first outer wall surface and spaced apart from each other, said fifth heat-dissipating fins projecting respectively from said first plate sections of said first plates.

10. The lamp as claimed in claim 5, wherein each of said second plates has a third plate section spaced apart from said second outer wall surface, and two fourth plate sections interconnecting said third plate section and said second outer wall surface and spaced apart from each other, said sixth heat-dissipating fins projecting respectively from said third plate sections of said second plates.

11. The lamp as claimed in claim 5, wherein said lighting module includes a substrate and at least one light emitting element disposed on said substrate, said substrate having a bottom surface and a periphery, said first base element further including a top wall connected to said first outer surrounding wall, said top wall having a first top surface, a second top surface disposed below said first top surface, and an inner side surface interconnecting said first and second top surfaces, said inner side surface cooperating with said second top surface to define a recessed area, said lighting module being disposed on said second top surface and within said recessed area.

12. The lamp as claimed in claim 11, wherein said base unit further includes a heat conducting member surrounding said substrate and disposed between and abutting against said periphery of said substrate and said inner side surface of said top wall.

13. A lamp base adapted to permit a lighting module to be disposed thereon, said lamp base comprising:
a base unit including
a first base element including a first body and a plurality of first plates, said first plates cooperating with said first body to define a plurality of first channels, said first body being adapted to permit the lighting module to be disposed thereon, and
a second base element including a plurality of second plates and a second body that are connected respectively to said first plates and said first body, said second plates cooperating with said second body to define a plurality of second channels, respectively, said second channels being in fluid communication with said first channels, respectively, and being adapted to permit flow of air therethrough, said second base element having a thermal conductivity that is lower than that of said first base element; and
a plurality of heat-dissipating fins formed on at least one of said first and second base elements.

14. The lamp base as claimed in claim 13, wherein said heat-dissipating fins include a plurality of first heat-dissipating fins formed on said first base element, and a plurality of second heat-dissipating fins formed on said second base element, said first heat-dissipating fins being arranged in a plurality of spaced groups that are arranged alternately with said first plates, such that each group of said first heat-dissipating fins is disposed between two adjacent ones of said first plates, said second heat-dissipating fins being arranged in a plurality of spaced groups that are arranged alternately with said second plates, such that each of said groups of said second heat-dissipating fins is disposed between two adjacent ones of said second plates.

15. The lamp base as claimed in claim 13, wherein said first body includes an annular first outer surrounding wall that has a first outer wall surface, said first plates being connected to said first outer wall surface of said first outer surrounding wall, said second body including an annular second outer surrounding wall that has a second outer wall surface, said second plates being connected to said second outer wall surface of said second outer surrounding wall.

16. The lamp base as claimed in claim 15, wherein said heat-dissipating fins further includes a plurality of third heat-dissipating fins formed on said first outer wall surface of said first outer surrounding wall and each extending into a corresponding one of said first channels, a plurality of fourth heat-dissipating fins formed on said second outer wall surface of said second outer surrounding wall and each extending into a corresponding one of said second channels, a plurality of fifth heat-dissipating fins formed respectively on said first plates, and a plurality of sixth heat-dissipating fins disposed respectively on said second plates, said fifth heat-dissipating fins abutting respectively against said sixth heat-dissipating fins when said first and second base elements are interconnected.

17. The lamp base as claimed in claim 15, wherein said first base element further includes a top wall connected to said first outer surrounding wall, said top wall having a first top surface, a second top surface disposed below said first top surface, and an inner side surface interconnecting said first and second top surfaces, said inner side surface cooperating with said second top surface to define a recessed area, said lighting module being disposed on said second top surface and within said recessed area.

18. The lamp base as claimed in claim 17, wherein said base unit further includes a heat conducting member surrounding said substrate and disposed between and abutting against said periphery of said substrate and said inner side surface of said top wall.

19. The lamp base as claimed in claim 13, wherein said heat-dissipating fins include a plurality of first heat-dissipating fins formed on said first base element, and a plurality of second heat-dissipating fins formed on said second base element.

20. A lamp base adapted to permit a lighting module to be disposed thereon, said lamp base comprising:
a base unit including
a first base element including a first body and
a first plate, said first plate cooperating with said first body to define a first channel, said first body being adapted to permit the lighting module to be disposed thereon, and
a second base element including a second plate and a second body that are connected respectively to said first plate and said first body, said second plate cooperating with said second body to define a second channel, said second channel being in fluid communication with said first channel and being adapted to permit flow of air therethrough, said second base element having a thermal conductivity that is lower than that of said first base element, and
a plurality of heat-dissipating fins formed on at least one of said first and second base elements.
